(19) United States
(12) Patent Application Publication
(10) Pub. No.: US 2007/0242589 A1
(43) Pub. Date: Oct. 18, 2007

(54) Stabilizing holographic disk medium against vibrations and/or controlling deflection of disk medium

(75) Inventors: Ian Russell Redmond, Boulder, CO (US); Gregory P. Hertrich, Longmont, CO (US); Mark Ayres, Boulder, CO (US); Keith Malang, Longmont, CO (US)

Correspondence Address: JAGTIANI + GUTTAG, 10363-A DEMOCRACY LANE, FAIRFAX, VA, 22030, US

(73) Assignee: InPhase Technologies, Inc., Longmont, CO (US)

(21) Appl. No.: 11/402,837

(22) Filed: Apr. 13, 2006

(51) Int. Cl. G11B 7/00

(52) U.S. Cl. 369/103

(57) ABSTRACT

The present invention relates to: stabilizing a holographic disk medium against vibrations by engaging at least one of surface of a disk medium when coupled to a disk medium coupler and during recording or reading holograms to or from the disk; stabilizing the disk medium proximate the outer peripheral portion thereof, coupling and uncoupling the disk medium to and from the disk medium coupler and causing the stabilizing means to engage the disk medium when coupled to the disk medium coupler; imparting an axial offset proximate the peripheral portion to deflect a record and/or read portion of the disk medium towards a normal record and/or read plane when coupled to the disk medium coupler, and optionally stabilizing the disk medium against vibrations; and stabilizing the disk medium against vibrations when rotatably mounted on or within a data storage cartridge.

### BACKGROUND

1. Field of the Invention

The present invention generally relates to stabilizing a holographic disk medium against vibrations during recording of holograms to or reading of holograms from the disk medium. The present invention further generally relates to controlling deflection of the disk medium during recording of holograms to or reading of holograms from the disk medium.

2. Related Art

Data storage cartridges have been used to house removable data storage media. The cartridge typically comprises a housing that serves as a protective enclosure for the disk medium. In the past, this disk medium has been in the form of a magneto-optical (MO) disk medium. However, another type of data storage system known as holographic storage is described in, for example, U.S. Pat. No. 5,719,691 (Curtis et al.), issued Feb. 17, 1998, and U.S. Pat. No. 6,191,875 (Curtis et al.), issued Feb. 20, 2001. In some applications, it may be desirable that the holographic data storage (HDS) medium be provided in a disk form and housed in a cartridge similar to those used for an MO disk medium. This enables HDS manufacturers to utilize existing MO cartridge designs and handling mechanisms for easy conversion to HDS applications. See, for example, commonly assigned U.S. Patent Application 2005/0028185 (Hertrich), published Feb. 5, 2005 and U.S. Patent Application 2005/0028186 (Hertrich), published Feb. 5, 2005, the entire disclosure and contents of which are incorporated by reference, for some illustrative data storage cartridges for holographic disk media.

These removable data storage cartridges typically comprise a disk-shaped data storage medium having a rotatable hub provided or attached at the center of the disk medium, and are inserted into data storage drives that can write data to and read data from such removable data cartridges. Some data storage drives include a “soft load” mechanism, which receives a data cartridge inserted into a load port of the drive, and translates the cartridge to couple the hub of the data cartridge with a spindle mechanism in the drive. The loading mechanism typically translates the cartridge first in a lateral direction to draw the cartridge fully into the drive, and then in a downward direction to lower the cartridge onto a stationary drive spindle. After coupling, the drive spindle rotates the data storage disk medium (typically circular shaped) past a radially positionable write/read head, which can write data to and/or read data from various locations on the disk medium.

During the writing (recording) and/or reading operation, it may be necessary to ensure that not only is the optical write/read head assembly accurately positioned to a predetermined storage location on the surface of the disk medium, but also that movement of the disk medium is minimized during either recording to, or reading from, the disk medium. Undesired movement may occur due to excess vibrations imparted to the disk medium. These imparted excess vibrations may be caused by or come from a variety of sources. See U.S. Pat. No. 5,526,337 (Housey et al.), issued Jun. 11, 1996, which discloses using a layer of cloth material disposed on the interior surfaces of the cover 24 (see FIG. 11) as a damping effect to remove or minimize such vibrations. Recording of holograms to the disk medium, as well as reading holograms from the disk medium, may also be sensitive to changes in the axial position and radial tilt angle of the plane of the disk medium, relative to the optical write/read head assembly.

Accordingly, it would be desirable to provide a holographic recording (writing) and/or reading system that is able to: (1) minimize, reduce or eliminate the effects that may be caused by vibrations imparted to the disk medium during recording of holograms, reading of holograms, or both, to or from the disk medium; (2) deal effectively with potential changes in the axial position and radial tilt angle of the plane of the disk medium, relative to the optical write/read head assembly.

### SUMMARY

According to a first broad aspect of the present invention, there is provided an apparatus comprising:
a disk medium coupler for releasably coupling and uncoupling a holographic disk medium, the disk medium having first and second laterally spaced apart surfaces and an outer peripheral portion; and
means engaging at least one of the first and second surfaces proximate the peripheral portion to thereby stabilize the disk medium against vibrations when the disk medium is coupled to the disk medium coupler.

According to a second broad aspect of the present invention, there is provided an apparatus comprising:
a disk medium coupler for releasably coupling and uncoupling a holographic disk medium, the disk medium having an outer peripheral portion;
means for stabilizing the disk medium proximate the peripheral portion against vibrations when the disk medium is coupled to the disk medium coupler; and
means for coupling and uncoupling the disk medium to and from the disk medium coupler; and for causing the stabilizing means to engage the disk medium when coupled to the disk medium coupler.

According to a third broad aspect of the present invention, there is provided an apparatus comprising:
a holographic data storage cartridge having:
   a holographic disk medium having an outer peripheral portion; and
   a housing for rotatably mounting the disk medium; and
means associated with the housing for stabilizing the disk medium proximate the peripheral portion against vibrations when the disk medium is coupled to a disk medium coupler.

According to a fourth broad aspect of the present invention, there is provided an apparatus comprising:
a disk medium coupler for releasably coupling and uncoupling a holographic disk medium having an outer peripheral portion; and
means for imparting an axial offset to the disk medium proximate the peripheral portion to deflect a record and/or read portion of the disk medium towards a normal record and/or read plane when coupled to the disk medium coupler.

According to a fifth broad aspect of the present invention, there is provided a method comprising the following steps:
(a) providing a holographic disk medium having first and second laterally spaced apart surfaces and an outer peripheral portion; and
(b) engaging at least one of first and second surfaces proximate the peripheral portion to stabilize the disk medium against vibrations during recording of holograms to or reading of holograms from the disk medium.

According to a sixth broad aspect of the present invention, there is provided a method comprising the following steps:
(a) providing a holographic disk medium having an outer peripheral portion; and
(b) engaging the disk medium proximate the peripheral portion to stabilize the disk medium against vibrations and to deflect a record and/or read portion of the disk medium towards a normal record and/or read plane during recording of holograms to or reading of holograms from the disk medium.

### BRIEF DESCRIPTION OF THE DRAWINGS

The invention will be described in conjunction with the accompanying drawings, in which:

FIG. 1 is a top plan view of a holographic disk medium coupled to a spindle drive assembly;

FIG. 2 is a side sectional view taken along line 2-2 of FIG. 1, also illustrating the inherent vibrations that may affect the recording to/reading from the disk medium;

FIG. 3 is an enlarged view of an encircled portion of the coupled disk medium and spindle drive assembly of FIG. 2;

FIG. 4 is a side sectional view of a holographic disk medium to illustrate displacement below and/or above the normal record and/or read plane due to inherent waviness of disk medium;

FIG. 5 is a side section view of a holographic disk medium to illustrate displacement below and/or above the normal record and/or read plane due to axial tilting of the disk medium.

FIG. 6 is a top plan view of a disk medium holder test bed disk medium holder showing a prior stabilizing device in the form of a mechanical arm for stabilizing a holographic disk medium against vibrations;

FIG. 7 is a top plan view of a disk medium holder test bed showing another prior stabilizing device in the form of a roller assembly mounted on the test bed for stabilizing a holographic disk medium against vibrations;

FIG. 8 is a top plan view with portions broken away showing an embodiment of a data storage cartridge of the present invention rotatably mounting a holographic disk medium within the data storage cartridge, and further comprising a roller assembly associated with the data storage cartridge for stabilizing the disk medium against vibrations;

FIG. 9 is a perspective view of a data storage cartridge (with components removed for clarity) loaded into a data drive with the holographic disk medium of the cartridge coupled to the spindle drive assembly of the data drive, and further illustrating an embodiment of a roller assembly of the present invention mounted on the carrier sled of the data drive for stabilizing the coupled disk medium against vibrations, as well as controlling deflection of the disk medium;

FIG. 10 is an enlarged view of FIG. 9 showing only the disk medium, carrier sled, roller assembly, and spindle drive assembly components of the data drive;

FIG. 11 is side sectional view of the disk medium, carrier sled, roller assembly, and the spindle drive assembly of FIG. 10, taken along line 11-11 of FIG. 10;

FIG. 12 is side sectional view similar to FIG. 11, but without the roller assembly;

FIG. 13 is an enlarged view of an encircled portion of FIG. 11 to further illustrate the roller assembly, and its positioning and orientation relative to the disk medium for stabilizing the disk medium against vibrations, as well as controlling deflection thereof, and

FIG. 14 is a side sectional view taken along line 14-14 of FIG. 13.

### DETAILED DESCRIPTION

It is advantageous to define several terms before describing the invention. It should be appreciated that the following definitions are used throughout this application.

### DEFINITIONS

Where the definition of terms departs from the commonly used meaning of the term, applicant intends to utilize the definitions provided below, unless specifically indicated.

For the purposes of the present invention, the term “holographic system” refers to any system that may record/write holograms (e.g., holographic data), read holograms, or both, to and/or from a holographic disk medium.

For the purposes of the present invention, the term “holographic disk medium” refers to a disk medium for recording/writing and/or reading, in three dimensions (i.e., the X, Y and Z dimensions), one or more holograms as one or more pages as patterns of varying refractive index imprinted into the medium. Embodiments of the holographic disk medium often have a circular shape and comprise a pair of laterally spaced apart first and second sides or surfaces (often an upper side/surface and a lower side/surface) and a peripheral circular edge.

For the purposes of the present invention, the terms “holographic grating,” “holograph” or “hologram” (collectively and interchangeably referred to hereafter as “hologram”) are used in the conventional sense of referring to a recorded interference pattern formed when a signal beam and a reference beam interfere with each other. The hologram may represent data (i.e., holographic data), a picture, an image, etc. In cases where digital holographic data is recorded, the signal beam may be encoded with a spatial light modulator.

For the purposes of the present invention, the term “recording” refers to recording, writing, storing, etc., one or more holograms on or in the holographic disk medium.

For the purposes of the present invention, the term “reading” refers to retrieving or recovering one or more recorded, written, stored, etc., holograms from the holographic disk medium.

For the purposes of the present invention, the term “holographic data storage (HDS) cartridge” refers to a data storage cartridge that comprises a protective housing and a holographic disk medium for recording (writing) holograms to and/or reading holograms from. The holographic disk medium is often rotatable within the housing. For data storage cartridges, such as HDS cartridges, that contain a rotatable disk medium, the disk medium of the data storage cartridge is often coupled with or to a rotatable disk medium coupler (e.g., a spindle hub of a spindle drive assembly, etc.) that rotates the disk medium within the housing.

For the purposes of the present invention, the term “disk medium coupler” refers to a component or mechanism that a holographic disk medium, with or without a data storage cartridge, is coupled with or to (e.g, a spindle hub of a spindle drive assembly) for recording and/or reading data by a write/read head For data storage cartridges, the disk medium coupler often rotates the disk medium within the data storage cartridge.

For the purposes of the present invention, the term “data drive” refers to a device embodying a holographic system that may comprise various components, including a disk medium coupler (e.g., a spindle hub of a spindle drive assembly) for releasably coupling a holographic disk medium thereto, a drive door assembly for receiving and/or ejecting the disk medium (alone or as part of a data storage cartridge), a disk medium/data cartridge loading/unloading mechanism for coupling or uncoupling the disk medium (alone or as part of a data storage cartridge) to or from the disk medium coupler and for optionally translating the disk medium/coupler combination to and/or from a write/read head for writing (recording) data to and/or reading data from the disk medium, etc.

For the purposes of the present invention, the term “disk medium loading and unloading mechanism” refers to a mechanism used to load/couple, unload/uncouple, or reversibly load/couple and unload/uncouple a holographic disk medium or a data storage cartridge comprising a disk medium. This loading/unloading mechanism may be referred to as a “data storage cartridge loader/unloader” when loading/unloading a data storage cartridge to or from a data drive. The loading/unloading mechanism may also translate the disk medium/coupler combination to and/or from a write/read head for writing (recording) data to and/or reading data from the disk medium, or the write/read head may be translated to a medium/coupler combination.

For the purposes of the present invention, the terms “unloading” and “ejecting” and similar terms are used interchangeably herein to refer to when a disk medium (e.g., as part of a data storage cartridge) is moved or otherwise positioned proximate the loading portion of a data drive (e.g., a load port) for manual removal from the data drive.

For the purposes of the present invention, the term “write/read head” refers to any device, assembly, mechanism, etc., that can write (record) data to and/or read data from the disk medium, including a disk medium associated with a data storage cartridge.

For the purposes of the present invention, the term “radial vibrations” refer to those vibrations occurring in a holographic disk medium radially inwardly from at or proximate the periphery thereof and/or outwardly from at or proximate the center thereof within a plane defined by or encompassing the disk medium, and substantially perpendicular to the disk medium coupler axis.

For the purposes of the present invention, the term “axial vibrations” refer to those vibrations occurring in a holographic disk medium perpendicular or substantially perpendicular to the plane of the disk medium, and often downwardly and/or upwardly along a disk medium coupler axis (e.g., a drive spindle shaft axis), or parallel or substantially parallel to the disk medium coupler axis.

For the purposes of the present invention, the term “radial line” refers to any line drawn or extending radially from proximate the center of a holographic disk medium to proximate the peripheral edge thereof.

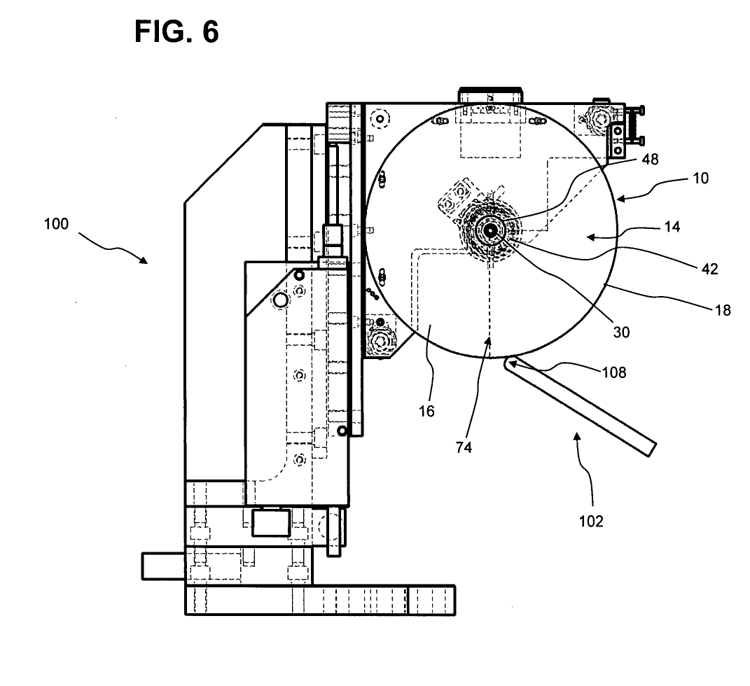

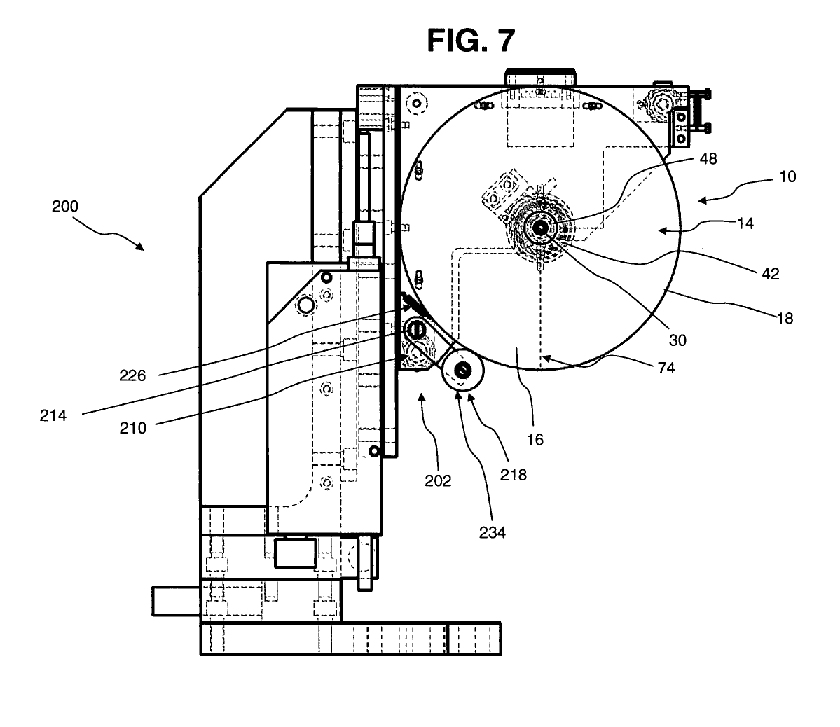

For the purposes of the present invention, the term “disk medium holder test bed” refers to a type of disk drive that is used in testing a holographic disk medium. Illustrations medium holder test bed are shown in FIGS. 6 and 7, as described hereafter.

For the purposes of the present invention, the term “record and/or read portion of the disk medium” refers to any portion of the holographic disk medium where one or more holograms may be recorded on, read from or recorded to and read from, the disk medium. The record and/or read portion may comprise a linear axis of the holographic disk medium (e.g., a radial line), a planar area of the disk medium, etc.

For the purposes of the present invention, the term “normal record and/or read plane” refers to a plane that the holographic disk medium, or portion thereof, is normally, usually, typically, ideally, desirably, etc., oriented in for recording, reading or recording and reading holograms to or from the disk medium when coupled to a disk medium coupler. For recording and/or reading holograms to or from a disk medium that is oriented generally horizontally when coupled to a disk medium coupler, the normal record and/or read plane is typically a substantially horizontal plane. For writing and/or reading holograms to or from a disk medium that is oriented generally vertical when coupled to a disk medium coupler, the normal record and/or read plane is typically a substantially vertical plane. However, depending on how holograms are normally recorded and/or read to or from the disk medium, the normal record and/or read plane may have orientations other than substantially horizontal or substantially vertical.

For the purposes of the present invention, the term “normal displacement” refers to the degree to which a portion of the holographic disk medium is above or below the normal record and/or read plane when coupled to the disk medium coupler and before any deflection is imparted to the disk medium.

For the purposes of the present invention, the terms “deflection” or “deflect” refer to imparting an axial offset to the holographic disk medium such that a record and/or read portion of the disk medium is at least displaced or moved towards the normal record and/or read plane when the disk medium is coupled to a disk medium coupler. This axial offset imparted to the disk medium may be sufficient, for example, to cause smoothing or flattening of the deflected portion of the disk medium to minimize or eliminate inherent waviness, etc. This axial offset may also cause the deflected portion of the disk medium to be slightly curved because of the disk medium being coupled to the disk medium coupler.

For the purposes of the present invention, the term “substantially level” refers to when a record and/or read portion of the holographic disk medium is deflected such that the record and/or read portion approaches, is substantially aligned with or parallel with the normal record and/or read plane so that recording and/or reading of holograms to or from the disk medium is minimally affected or not affected at all.

For the purposes of the present invention, the term “deflection angle” refers to the angular degree to which the record and/or read portion of the holographic disk medium is tilted, rotated, etc., relative to the plane defining the disk medium when coupled to the disk medium coupler.

For the purposes of the present invention, the term “axial tilt” refers to any change in the axis of rotation of the disk medium coupler, relative to its normal axis of rotation, e.g., the normal rotational axis of the spindle drive shaft. For example, the normal axis of rotation of a disk medium coupler is often either a substantially vertical axis or a substantially horizontal axis.

For the purposes of the present invention, the term “proximate” includes the terms at, near, adjacent, adjoining, etc.

Description

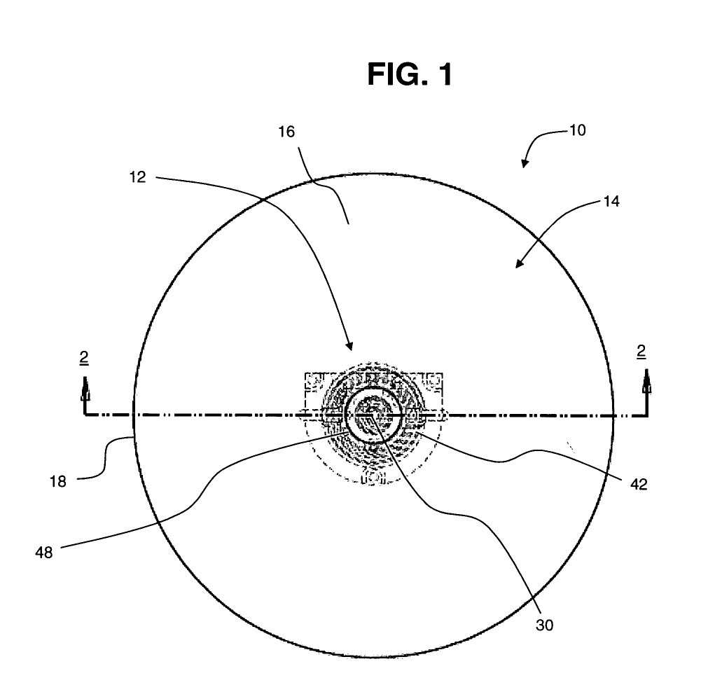

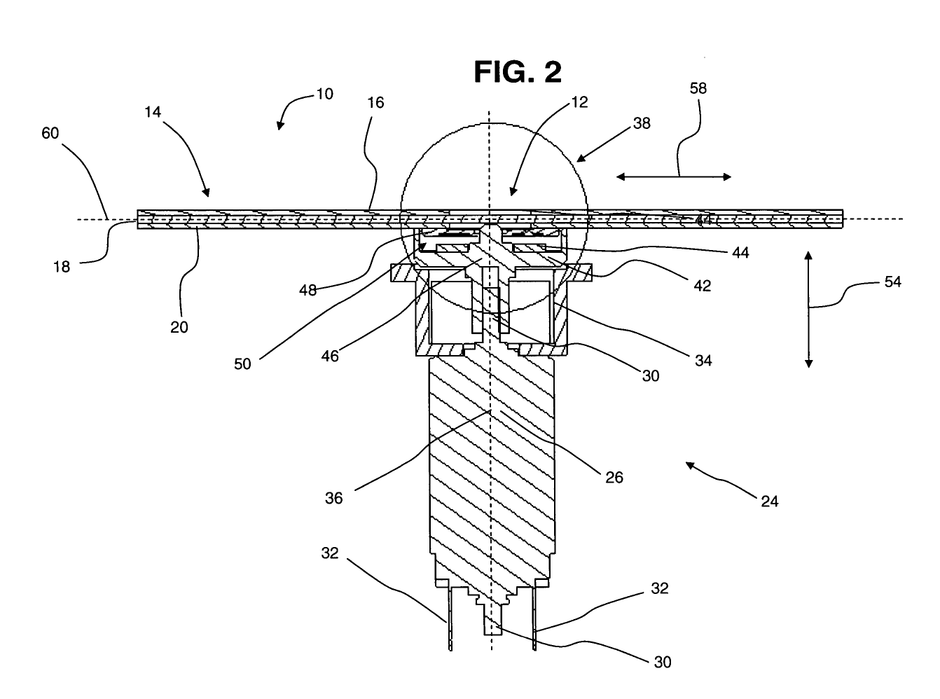

In holographic recording, it has been found that inherent vibrations of the holographic disk medium may affect the writing (recording) and subsequent readback quality of the holograms recorded on or in a holographic disk medium. The vibrations that may be imparted to the holographic disk medium are illustrated by reference to FIGS. 1-2 which show a holographic disk medium (hereafter referred to as “disk”), indicated generally as 10, and having a generally circular shape. As illustrated in FIG. 2, disk 10 is oriented generally horizontally. Disk 10 includes a central portion, indicated generally as 12, and an annular outer perimeter or peripheral portion, indicated as 14. Disk 10 also has an upper side or surface, indicated as 16, a peripheral edge, indicated as 18, and a lower side or surface, indicated as 20, that is laterally spaced apart (often vertically) from upper side/surface 16.

Disk 10 is mounted on or coupled to or with a disk medium coupler that often comprises a portion of a drive assembly, for example, in the form of a spindle drive assembly, indicated generally as 24. Spindle drive assembly 24 includes a spindle drive motor, indicated generally as 26, a rotating spindle drive shaft 30 extending from the bottom end to the top end of assembly 24, electrical connections, indicated generally as 32, proximate the bottom end of assembly 24 for supplying power to spindle drive motor 26, and a mounting bracket, indicated generally as 34, above spindle drive motor 26, for mounting assembly 24 on or within another component of a data drive, for example, a carrier sled, as described below. As illustrated in FIG. 2, assembly 24 and in particular spindle drive shaft 30 are oriented generally vertically such that shaft rotates about a substantially vertical axis, indicated by dashed line 36.

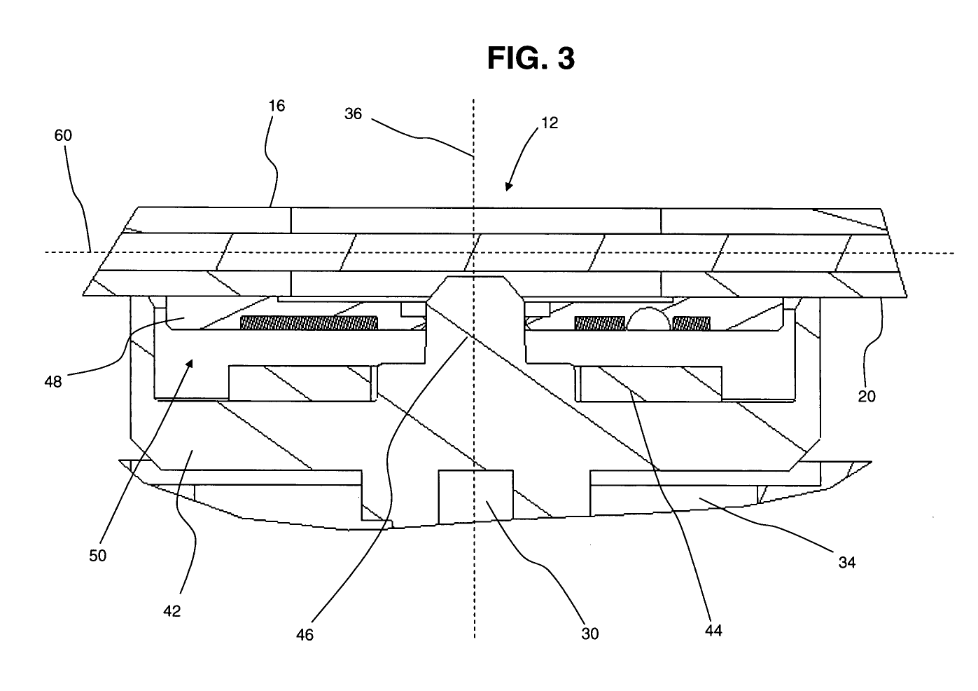

The interaction between the components comprising disk 10 and spindle drive assembly are further illustrated by FIG. 2 and particularly FIG. 3, which shows an enlarged encircled portion of the FIG. 2 indicated by arrow 38. As shown in FIG. 2 and particularly in FIG. 3, the upper end of shaft 30 engages or is otherwise connected to spindle hub 42 for rotation thereof. An annular shaped magnet 44 may encircle the central portion 46 of spindle hub 42. Disk hub 48, which is mounted or otherwise attached to the lower side or surface 20 of disk 10, is sized to fit within and be received by a recess or receptacle 50 of spindle hub 42. Disk hub 48 may be held in place within receptacle 50 by magnet 44. As a result, as shaft 30 rotates, disk 10 rotates due to the coupled combination of spindle hub 42 and disk hub 48 created by magnet 44.

Because of the relatively large diameter of the disk 10 (e.g., from about 120 to about 130 mm), disk 10 may be subjected to the axial vibrations, indicated generally by vertical double headed arrow 54 in FIG. 2, as well as radial vibrations, indicated generally by horizontal double headed arrow 58 in FIG. 2. These axial vibrations 54 and radial vibrations 58 may be induced by various electromechanical components, e.g., shutters, solenoids, etc., present on or in the data drive, including those components present on or in spindle drive assembly 24, and/or a data storage cartridge (i.e., when disk 10 is rotatably mounted therein). Air movement may also induce the axial vibrations 54 and/or radial vibrations 58 within disk 10, which may make holographic recording (or reading) more difficult.

These axial vibrations 54 and/or 58 radial vibrations may make effective holographic recording on disk 10 (as well reading from disk 10) more difficult or even impossible, and may make the quality of the hologram recorded on disk 10 poorer, or possibly even unacceptable. Because disk 10 may be rotating continuously during, for example, recording (e.g., if a sufficiently short pulsed exposure is used to record the holograms on disk 10), or may be rotated to a given or fixed angular position and then stopped or paused at this angular position during recording, with this process of rotating disk 10 to a given/fixed angular position and then stopping/pausing disk 10 for recording being repeated many times. In either case, axial and/or radial vibrations 54 and 58 of disk 10 may degrade the recording of the hologram if a sufficiently great vibrational movement or motion occurs during recording exposure of the hologram on disk 10. (Similar or analogous adverse affects may also be experienced during the reading of holograms from disk 10).

Besides axial and/or radial vibrations 54/58, it has further been found that controlling the degree deflection of disk 10 of that portion of disk 10 (e.g., along a radial line) where hologram recording (or reading) is taking place, may be necessary in order to guarantee or at least improve hologram recovery performance from disk 10. Recording of holograms on disk 10 by an optical write/read head assembly may be highly sensitive to changes in the axial position of disk 10, as well as the degree of displacement of the disk plane of disk 10, relative to the normal record and/or read plane, as indicated by dashed line 60 in FIGS. 2 and 3. (Reading of holograms by the optical write/read head assembly from the disk 10 may also be sensitive to changes in the axial position of disk 10, as well as the degree of displacement of the disk plane of disk 10, relative to the normal record and/or read plane 60.)

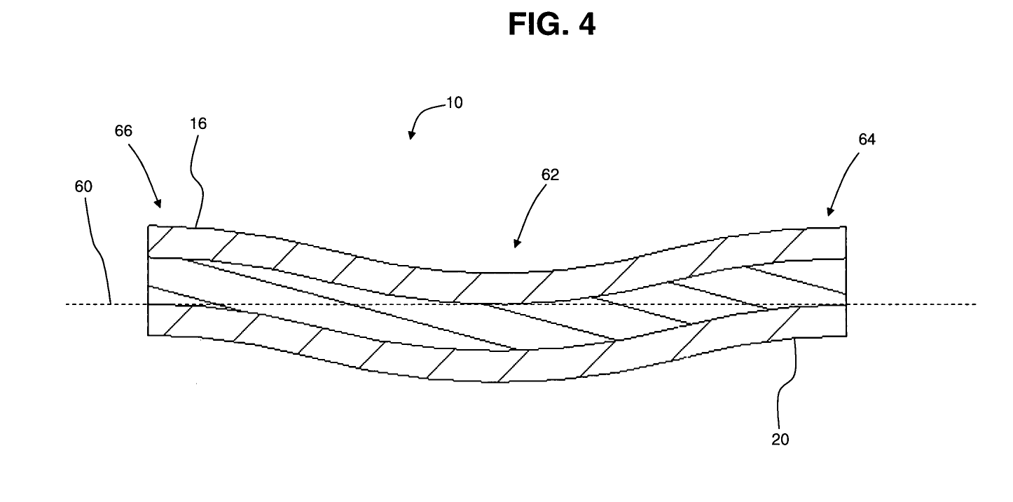

The inherent waviness of disk 10 may cause one or more record and/or read portions of disk 10 to be displaced from the normal record and/or read plane 60 of disk 10, for example, along a radial line. Displacement caused by inherent waviness of disk 10 is illustrated in FIG. 4. FIG. 4 shows a portion of disk 10 having one valley (relative to surface 16), indicated as 62, as well as two peaks, indicated as 64 and 66, on either side of valley 62. As reflected in FIG. 4, the portions of surface 16 proximate valley 62 are displaced below normal plane 60, while the portions of surface 16 proximate peaks 64 and 66 are displaced above normal plane 60.

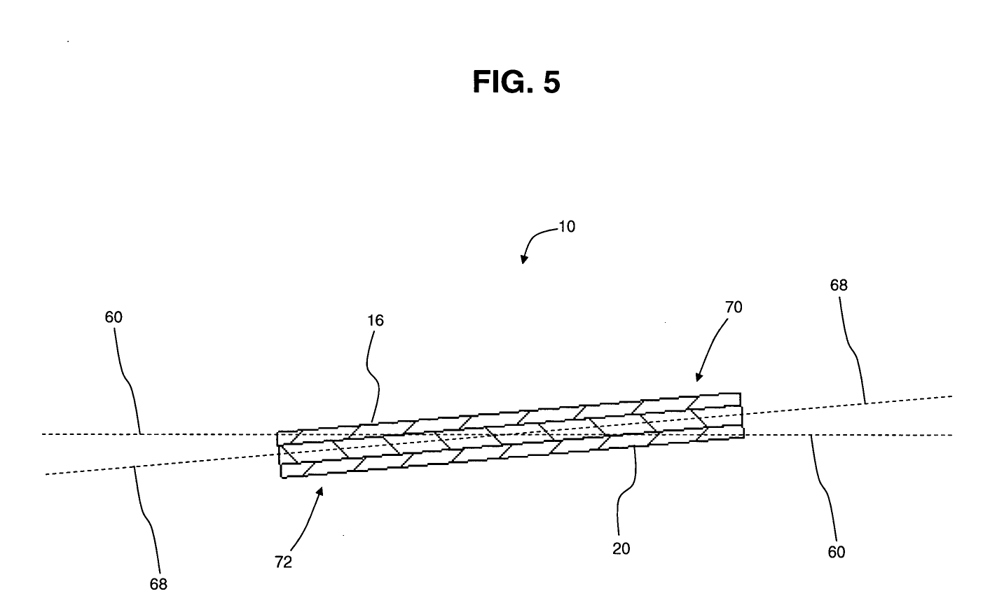

Displacement of one or more record and/or read portions of disk 10 may also be caused by an axial tilting from normal record and/or read 60, as to be aligned along a displacement plane, indicated by dashed line 68 in FIG. 5. Such axial tilting may be caused by, for example, how disk 10 is coupled to spindle hub 42 of spindle drive assembly 24, or by other mechanical properties of spindle drive assembly 24, such as for example, the rotational axis 36 of spindle shaft 30. Displacement caused by axial tilting of disk 10 is illustrated in FIG. 5. (While FIG. 5 illustrates a counterclockwise axial tilting of disk 10, disk 10 may also be axially tilted clockwise as well.) As shown in FIG. 5, because of such axial tilting of disk 10 such that it is aligned with displacement plane 68, a portion of disk 10, as indicated as 70, is above the normal record and/or read plane 60, while a portion of disk 10, as indicated by 72, is below the normal record and/or read plane 60. In fact, recording and/or reading of portions of disk 10 may affected not only by axially tilting (as shown in FIG. 5), but also by inherent waviness (as shown in FIG. 4).

The displacement of these record and/or read portions of disk 10 from the normal record and/or read plane 60 because of inherent waviness and/or axial tilting may cause deviations or errors in recording and/or reading holograms by the optical write/read head assembly to or from disk 10. Such deviations or errors may be sufficiently great or large so as to require a mechanism to avoid or minimize such deviations or errors. For example, a tilt and height servo system might be used to appropriately change or adjust the axial position and/or adjust the angle of disk 10 relative to the normal record and/or read plane 60 to avoid or minimize these deviations/errors. Unfortunately, such tilt and height servo systems may greatly increase the cost of the holographic recording system, e.g., the data drive.

It has been found that imparting an axial offset proximate peripheral portion 14 of disk 10 may be used to deflect a record and/or read portion (for example, along a radial line) of disk 10 towards the normal record and/or read plane 60 to provide more acceptable recording of holograms to (and reading of holograms from) disk 10. This controlled deflection of the record and/or read portion of disk 10 may be used to minimize or avoid deviations or error caused by inherent waviness of the disk 10 (as in FIG. 4) and/or an axial tilting of disk 10 from the normal record and/or write plane (as in FIG. 5) by causing the deflected portion of disk 10 to be in a repeatable position relative to normal record and/or read plane 60. For example, an axial offset may be imparted proximate peripheral portion 14 such that the deflected portion of disk 10 is substantially level with its normal record and/or read plane 60. This imparting of an axial offset to the peripheral portion 14 of disk 10 may also be carried out in conjunction or together with an intentional axial tilting of the disk medium coupler (e.g., spindle drive assembly 24) so that a consistent degree of deflection of the deflected portion of disk 10 is achieved, for example, such that the deflected portion is consistently substantially level with the normal record and/or read plane 60.

By imparting an axial offset proximate peripheral portion 14 of disk 10 (e.g., to overcome or compensate for inherent waviness and/or axial tilting of disk 10), control of the deflected portion of disk 10 may be achieved without the need of expensive tilt and height servo systems. For example, a relatively simple roller assembly may be used (as described below) to impart an axial offset proximate peripheral portion 14 of disk 10 to provide a controlled degree of deflection of any record and/or read portion of disk 10, including making this deflected portion of disk 10 substantially level with the normal record and/or read plane 60. This controlled deflection may also be imparted in those areas of peripheral portion 14 of disk 10 where holograms are not normally recorded (or read) so as to minimize the effect on the recording/reading capacity of disk 10. Control of the degree of deflection imparted to disk 10 may also be achieved in conjunction or together with variable or fixed axial tilting of the disk medium coupler (e.g., axial tilting of spindle drive assembly 24) to, for example, consistently cause the deflected portion of disk 10 to be substantially level with the normal record and/or read plane 60.

Disk medium holder test beds using prior devices for stabilizing disk 10 against axial and/or radial vibrations 54/58 are shown in FIGS. 6 and 7. In FIGS. 6 and 7, disk 10 is shown with a radial line, indicated as 74, that extends outwardly from proximate shaft 30 to peripheral edge 18 to provide a frame of reference for the positioning of the stabilizing device. FIG. 6 shows a disk medium holder test bed 100 to which is coupled disk 10 and which uses a device to stabilize this coupled disk 10 against axial and/or radial vibrations 54/58 in the form of a mechanical arm, indicated generally as 102. Arm 102, which is shown in FIG. 6 as being mounted separately from test bed 100, has a mechanical finger or tip, indicated as 108, at the distal end thereof that is in contact with or engages peripheral edge 18 of disk 10 proximate where radial line 74 intersects edge 18. While engagement of mechanical tip 108 against peripheral edge 18 may provide stabilization of disk 10 against axial and/or radial vibrations 54/58, tip 108 must typically be moved out of contact or engagement with peripheral edge 18 to enable disk 10 to be rotated to different angular positions. After disk 10 is rotated to each different angular position, mechanical tip 108 then needs to be carefully placed again in contact or engagement with peripheral edge 18 to provide stabilization of disk 10 against axial and/or radial vibrations 54/58 during recording (or reading) of holograms. As a result, use of a mechanical arm 102 according to FIG. 6 may cause a relatively slow rate of recording holograms on (or reading holograms from) disk 10 because of the need to constantly move tip 108 out of and then into contact or engagement with peripheral edge 18 to stabilize disk 10 against axial and/or radial vibrations 54/58 after each angular rotation.

FIG. 7 shows a disk medium holder test bed, indicated generally as 200, using another device for stabilizing disk 10 that is coupled to test bed 200 against axial and/or radial vibrations 54/58. This stabilizing device shown in FIG. 7 is in the form of a roller assembly, indicated generally as 202. Roller assembly 202 includes a roller support, indicated generally as 210, which is directly and pivotally mounted at one end, indicated generally as 214, on test bed 200. At the other distal end of roller support 210 is rotatably mounted a roller, indicated generally as 218. As shown in FIG. 7, roller 218 is biased against peripheral edge 18 of disk 10 by, for example, an extension spring, indicated generally as 226, that urges support 210 towards edge 18. Because roller 218 may rotate as disk 10 is rotated to different angular positions, disk 10 may be stabilized by roller 218 at these different angular positions without the need to constantly move roller 218 into and out of contact or engagement with peripheral edge 18. Even so, roller 218 may cause debris to be formed from the material comprising roller 218 because of the friction that may occur between the outer surface of roller 234 and peripheral edge 18 of disk 10. In addition, roller assembly 202 may provide minimal and typically no control over the deflection of disk 10 above (or below) the normal record and/or read plane 60.

Embodiments of the present invention provide different solutions from the devices shown in FIGS. 6 and 7 for minimizing, reducing, damping, eliminating, attenuating, etc., these axial and/or radial vibrations 54/58 that may be imparted to disk 10. Also unlike the devices of FIGS. 6 and 7, the present invention provides embodiments for stabilizing disk 10 against such vibrations when rotatably mounted on or within a data storage cartridge. In addition, embodiments of the present invention may provide the ability to control deflection of a record and/or read portion of disk 10, relative to the normal record and/or read plane 60, without the need of an expensive servo system.

Embodiments of the apparatus and method of the present invention include means and/or steps for stabilizing disk 10 against such axial and/or radial vibrations by engaging at least one of surfaces 16 or 20 of disk 10 when disk 10 is coupled to a disk medium coupler (e.g., spindle hub 42 of spindle drive assembly 24) and during recording holograms to or reading holograms from disk 10. Embodiments of the apparatus and method of the present invention also include means and/or steps for coupling and uncoupling disk 10 from a disk medium coupler (e.g., spindle hub 42 of spindle drive assembly 24), means and/or steps for stabilizing disk 10 proximate peripheral portion 14 when coupled to the disk medium coupler, and means and/or steps for coupling and uncoupling disk 10 to and from the coupler disk medium and for causing the stabilizing means to engage the disk medium when coupled to the disk medium coupler. Embodiments of the apparatus of the present invention also include a holographic data storage cartridge having a disk 10, and a housing for rotatably mounting disk 10, with means associated with the housing for stabilizing disk 10 proximate peripheral portion 14 against vibrations when disk 10 is coupled to a disk medium coupler (e.g., spindle hub 42 of spindle drive assembly 24). Embodiments of the apparatus and method of the present invention also include means and/or steps for imparting an axial offset to disk 10 proximate peripheral portion 14 to deflect a record and/or read portion of disk 10 (e.g., along a radial line 74) towards the normal record and/or read plane 60 when coupled to a disk medium coupler (e.g., drive spindle 42 of spindle drive assembly 24). Embodiments of the apparatus and method of the present invention further include means and/or steps for stabilizing disk 10 against axial and/or radial vibrations 54/58, as well as deflecting a record and/or read portion of disk 10 towards the normal record and/or read plane 60 when coupled to a disk medium coupler (e.g., drive spindle 42 of spindle drive assembly 24).

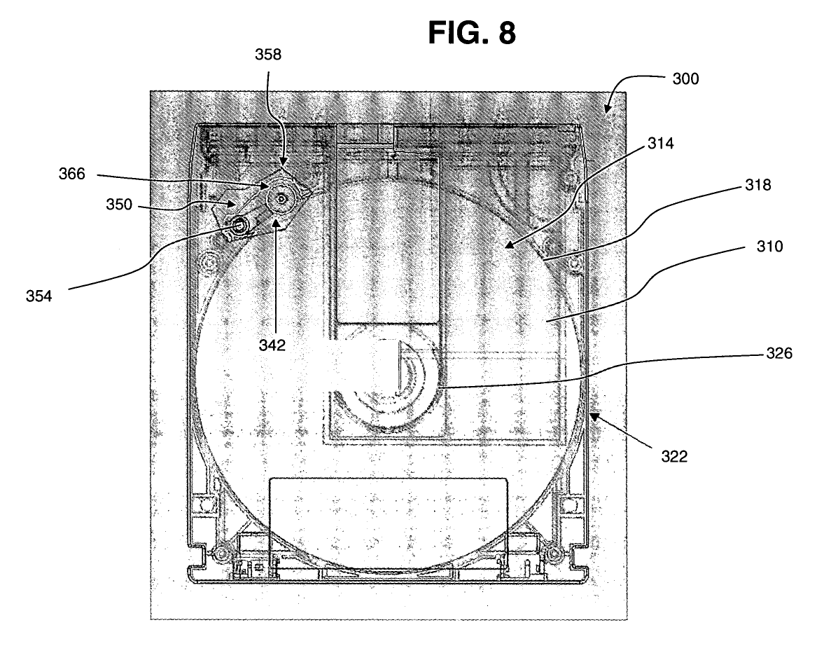

The various embodiments of the present invention are further illustrated by reference to FIGS. 8-14 of the drawings. One embodiment of an apparatus according to the present invention for use with a data storage cartridge, indicated generally as 300, is illustrated in FIG. 8. Illustrative data storage cartridges 300 that may be useful herein and modified according to the embodiment illustrated in FIG. 8 are disclosed in commonly assigned U.S. Patent Application 2005/0028185 (Hertrich), published Feb. 5, 2005 and in commonly assigned U.S. Patent Application 2005/0028186 (Hertrich), published Feb. 5, 2005, the entire disclosures and contents of which are incorporated by reference. As shown in FIG. 8, cartridge 300 includes a disk, indicated as 310, having a peripheral portion, indicated as 314, and a peripheral edge, indicated as 318. Disk 310 is rotatably mounted within a generally rectangular or squared-shaped cartridge housing, indicated generally as 322. Disk 310 may have secured or attached to the lower side or surface thereof a disk hub, indicated generally as 326. Cartridge 300 may be provided and associated with a device for stabilizing disk 310 against axial and/or radial vibrations, for example, in the form of a roller assembly, indicated generally as 342.

As further shown in FIG. 8, roller assembly 342 may be mounted within housing 322, and includes a roller support, indicated generally as 350. Support 350 may be mounted at one end thereof within housing 322 by a pivot pin, indicated as 354. A roller, indicated generally as 358, may be rotatably mounted proximate the other distal end of support 350. The outer surface 366 of roller 358 engages peripheral edge 318 to stabilize disk 310 against axial and/or radial vibrations when disk 310 is coupled to a disk medium coupler (e.g., when cartridge 300 is in loaded position within in a disk drive). Means may also provided for biasing or urging roller assembly 342, such as a extension or torsion spring (not shown), so that outer surface 366 of roller 358 continually engages peripheral edge 318, at least when recording of holograms on (or reading of holograms from) disk 310 is taking place. For example, one end of the extension spring may be connected to housing 322, while the other end of the spring is connected to roller support 350, in a manner such that support 350 is urged or biased to pivot about pin 354 so that the distal end of support 350 mounting roller 358 moves towards peripheral edge 318, and thus brings surface 366 of roller 358 into continual contact or engagement with peripheral edge 318. The ability of roller 358 to continually contact or engage peripheral edge 318 may also be enhanced by having roller 358 or at least surface 366 have a width greater than that of peripheral edge 318 of disk 310.

As further shown in FIG. 8, roller 358 has an axis of rotation that is generally the same or at least generally parallel to the axis of rotation of disk 310 (e.g., about disk hub 326). As a result, the plane defined by or encompassing roller 358 is generally aligned with, or at least generally parallel to the plane defined by or encompassing disk 310. Because roller 358 is typically urged or biased such that outer surface 366 of roller 358 is in continual contact or engagement with peripheral edge 318, roller 358 also typically rotates in response to the rotation of disk 310 within cartridge 300 to different angular positions. Because of the inclusion of roller assembly 342 as part of cartridge 300 of the embodiment of FIG. 8, disk 310 may be stabilized against vibrations during the recording of holograms to disk 310, as well as the reading of holograms from disk 310, without affecting the protection provided by housing 322 against light (i.e., due to the light sensitivity of the recording medium that disk 310 comprises).

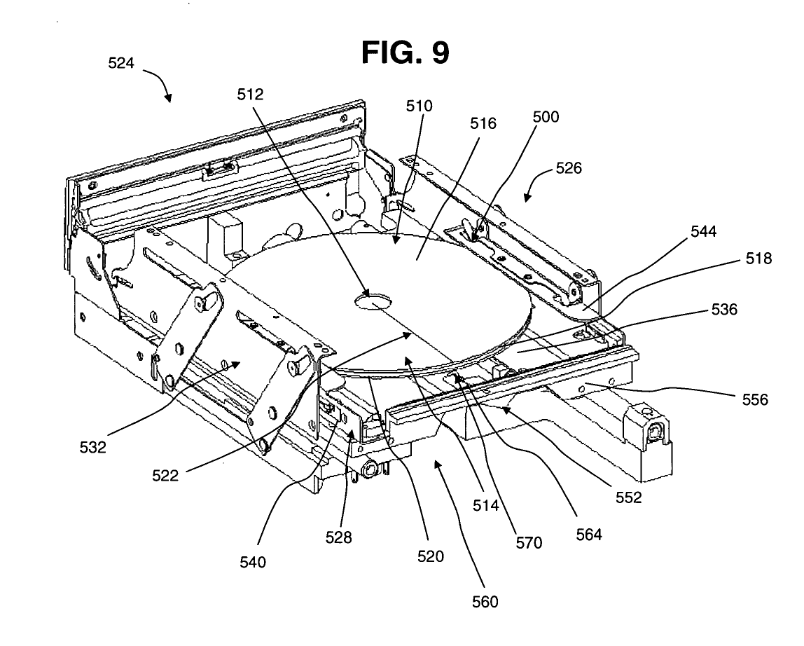

Another alternative embodiment of an apparatus according to the present invention for use with, for example, a data drive for receiving a data storage cartridge similar that shown in FIG. 8 is illustrated in FIGS. 9-14. The embodiment of FIGS. 9-14 provides the additional flexibility of locating the device for stabilizing disk 310 outside of cartridge 300 (e.g., roller assembly 342 need not be mounted on or within cartridge housing 322). In addition, the embodiment of FIGS. 9-14 provides the additional capability of controlling the deflection of disk 310 due to, for example, inherent waviness of disk 310, and without the need of, for example, an expensive media tilt and height servo system.

Referring to FIG. 9, a data storage cartridge, indicated generally as 500, is shown, with the cartridge housing removed for the purpose clarity. Cartridge 500 includes a holograph disk medium (hereafter referred to as “disk”), indicated generally as 510, that is rotatably mounted within the cartridge housing. As shown in FIG. 9, disk 510 has a central portion 512, an outer annular perimeter or peripheral portion 514, an upper side or surface 516, an outer peripheral edge 518, and a lower side or surface 520 laterally spaced apart (e.g., vertically) from upper side/surface 516. As also shown in FIG. 9, a radial line, indicated as 522, is provided which extends from proximate central portion 512, outwardly to proximate peripheral edge 518.

As further illustrated in FIG. 9, cartridge 500 may be loaded within a data drive, indicated generally as 524. An illustrative data drive 524 such as that shown in FIG. 9 is disclosed in commonly assigned co-pending U.S. Application (Hertrich et al), Ser. No. 11/283,864, filed Nov. 22, 2005, the entire disclosure and contents of which is incorporated by reference. As shown in FIG. 9, data drive 524 includes a cartridge loading and unloading mechanism (hereafter referred to as a “cartridge loader/unloader”), indicated generally as 526, for loading and unloading cartridge 500, and for coupling and uncoupling disk 510 of cartridge 500 to and from a disk medium coupler, for example, a spindle hub of a spindle drive assembly, as described below. Cartridge loader/unloader 526 includes a disk medium carrier in the form of a cartridge carrier, indicated generally as 528, for releasably receiving cartridge 500. Carrier 528, with cartridge 500, is moved between coupled and uncoupled positions to and from the disk medium coupler by a carrier guide assembly, indicated generally as 532. Carrier 528 shown in FIG. 9 as comprising a bottom portion, indicated as 536, and a pair of upwardly extending and laterally spaced apart side and upper guide portions, indicated generally as 540 and 544, respectively, for securely and releasably receiving cartridge 500.

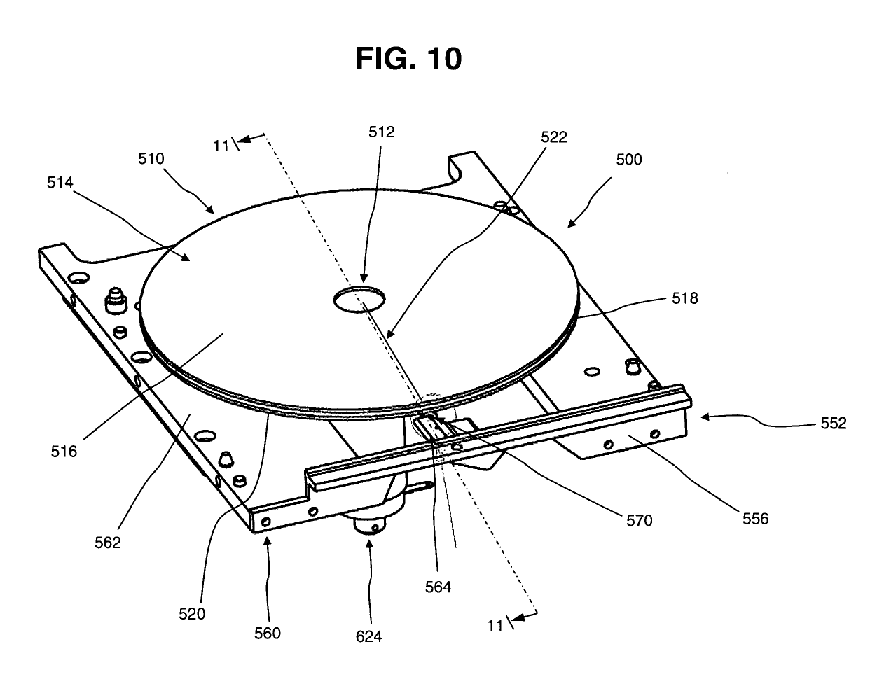

Referring to FIGS. 9 and 10, a device for stabilizing disk 510 against axial and/or radial vibrations is indicated generally as 552. Stabilizing device 552 includes a mounting bracket, indicated as 556, for mounting stabilizing device 552 on the rearward or trailing end 560 of a cartridge carrier transporter in the form of, for example, a laterally movable carrier sled, indicated generally as 562. Carrier sled 562 moves loader/unloader 526 and especially carrier 528, laterally forwards and backwards between cartridge loaded and unloaded positions in response to, for example, a carrier sled drive assembly (not shown). (The lateral movement of carrier sled 562 also actuates carrier guide assembly 532 to move carrier 528 between coupled and uncoupled positions relative to the disk medium coupler, as is described in commonly assigned co-pending U.S. Application (Hertrich et al), Ser. No. 11/283,864.) Stabilizing device 552 further includes a roller support, indicated generally as 564, that extends inwardly from mounting bracket 556. Rotatably mounted proximate the inwardly extending distal end of support 564 is a roller assembly, indicated generally as 570.

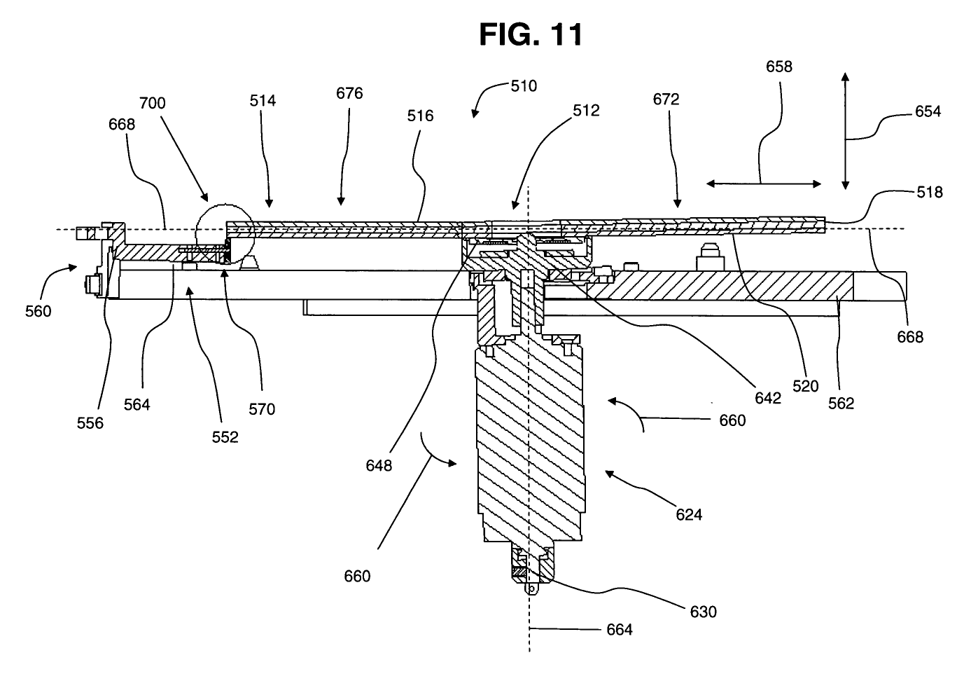

As further shown in FIGS. 10 and 11, carrier sled 562 has associated therewith a spindle drive assembly (e.g., the same or similar to spindle drive assembly 24), indicated generally as 624, which comprises a rotating spindle drive shaft 630 having a spindle hub 642 mounted thereon at the upper end thereof. Disk hub 648, which may be mounted on or attached to lower side/surface 520 of disk 510, is received by spindle hub 642 for coupling disk 510 to spindle drive assembly 624. When disk 510 is coupled to spindle drive assembly 624 by cartridge carrier 528 (e.g., due to actuation of carrier guide assembly 532 of loader/unloader 526 in response to lateral movement of carrier sled 562), the lower surface 520 of disk 510 is brought into contact and engagement with roller assembly 570 proximate peripheral portion 514 of disk 510. Although not shown in FIGS. 10 or 11, roller assembly 570 would extend through a suitably configured opening or aperture formed in the housing of cartridge 500 when disk hub 648 of disk 510 is coupled to spindle hub 642 of spindle drive assembly 624.

When disk hub 648 is coupled to spindle hub 642 of spindle drive assembly 624 by cartridge carrier 528, lower surface 520 of disk 510 engages roller assembly 570. As shown in FIG. 10, and particularly FIG. 11, roller assembly 570 is mounted on support 564 for rotation about an axis that is at least transverse, and potentially perpendicular, to the axis of rotation of spindle shaft 630 of spindle drive assembly 624. Accordingly, roller assembly 570 not only stabilizes disk 510 against axial vibrations (indicated by vertical double headed arrow 654) and/or radial vibrations (indicated by horizontal double headed arrow 658), but may also control the deflection, and particularly the degree of deflection, of disk 510, relative to the normal record and/or read plane of disk 510, and particularly along radial line 522 that is proximate to where roller assembly 570 engages peripheral portion 514 of disk 510, as described below. The normal record and/or read plane of disk 510 is generally represented in FIG. 11 by horizontal dashed line 668.

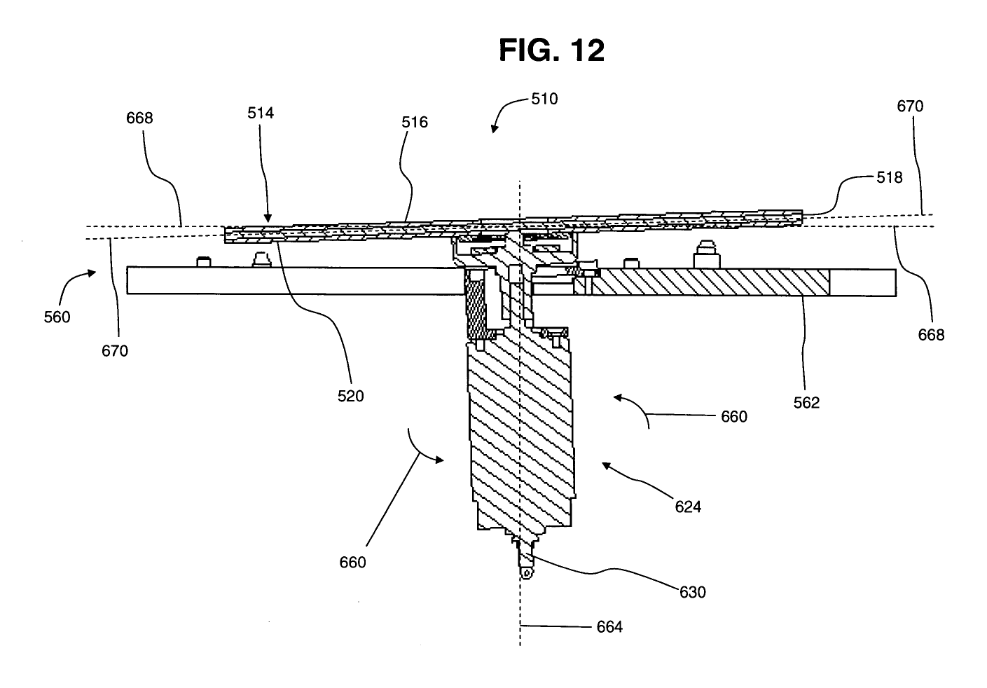

Spindle drive assembly 624 may also be mounted on or otherwise associated with carrier sled 562 to enable roller assembly 570 to impart better deflection control to disk 510, relative to this normal record and/or read plane 668. For example, as illustrated in FIGS. 11 and 12, when mounted on carrier sled 562, spindle drive assembly 624 may be axially tilted counterclockwise (e.g., up to about 0.5°), as indicated by a pair of curved arrows 660, relative to its normal rotational axis (e.g., the normal vertical rotational axis of spindle shaft 630), indicated by vertical dashed line 664. (Compare the orientation of spindle drive assembly 624 relative to vertical axis 664, with the orientation of spindle drive assembly 24 shown in FIG. 2, relative to rotational axis 36 of spindle shaft 30.) This axial tilting 660 of spindle drive assembly 624 may be varied manually or automatically, but may also be locked in to provide a relatively fixed degree of axial tilting when mounted on carrier sled 562.

As illustrated in FIG. 12, in the absence of roller assembly 570, this axial tilting 660 of spindle drive assembly 624 would cause the entire plane of disk 510, relative to normal record and/or read plane 668, to be axially tilted so the entire plane of disk 510 would be aligned with the axially tilted plane, indicated by dashed line 670. By contrast, when roller assembly 570 is present as in FIG. 11, only the undeflected portion of disk 510, indicated generally as 672, remains axially tilted, i.e., where peripheral edge 518 is above normal record and/or read plane 668. More significantly, the axial tilting 660 of spindle drive assembly 624 causes coupled disk 510 to be brought into contact and engagement with roller assembly 570 proximate peripheral portion 514 (e.g., proximate peripheral edge 518), and thus causes a bending or upward deflection (e.g., up to about 400 microns when measure proximate peripheral edge 518) of disk 510, as indicated by deflected portion 676, towards normal record and/or read plane 668 such that deflected portion 676 may approach or be substantially level with plane 668. (Because central portion 512 of disk 510 is relatively fixed by being coupled to spindle drive assembly 624, deflected portion 676 is often slightly curved upwardly, with upper surface 516 being slightly concave and lower surface 520 be slightly convex.) In fact, axial tilting 660 of spindle drive assembly 624 may permit a consistent amount or degree of axial offset to be imparted by roller assembly 570 to lower surface 520 at peripheral portion 514 of coupled disk 510 such that deflected portion 676 of disk 510 is consistently and repeatably positioned relative to normal record and/or read plane 668. For example, because roller assembly 570 may be mounted on carrier sled 562 in a relatively fixed position, a consistent degree of axial tilting 660 of spindle drive assembly 624 may cause roller assembly 570 to consistently impart the same or a similar degree of axial offset to lower surface 520 of coupled disk 510 such that deflected portion 676 of disk 510 is consistently bent or forced upwardly to be substantially level with the normal record and/or read plane 668, as further described and illustrated below.

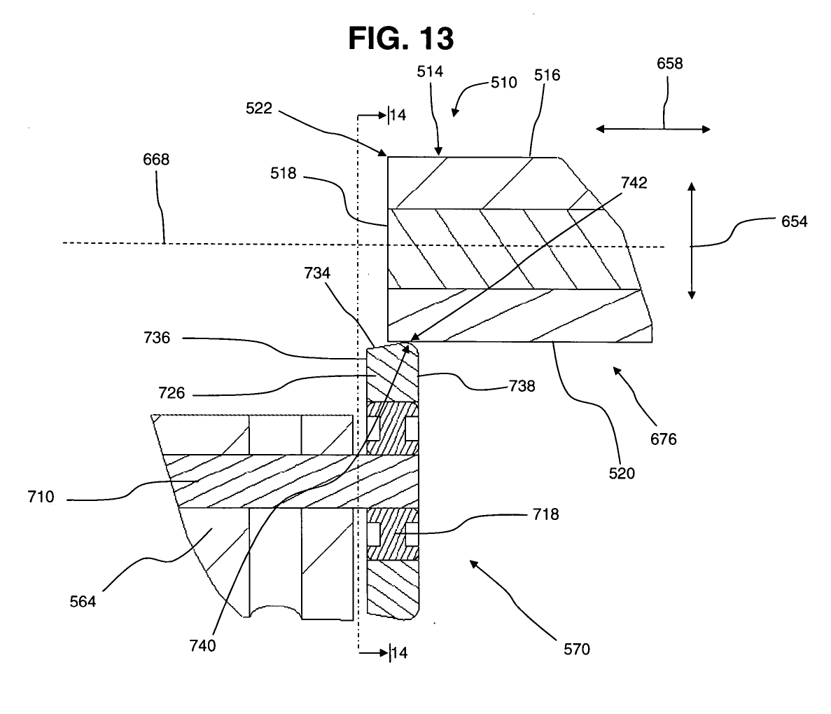

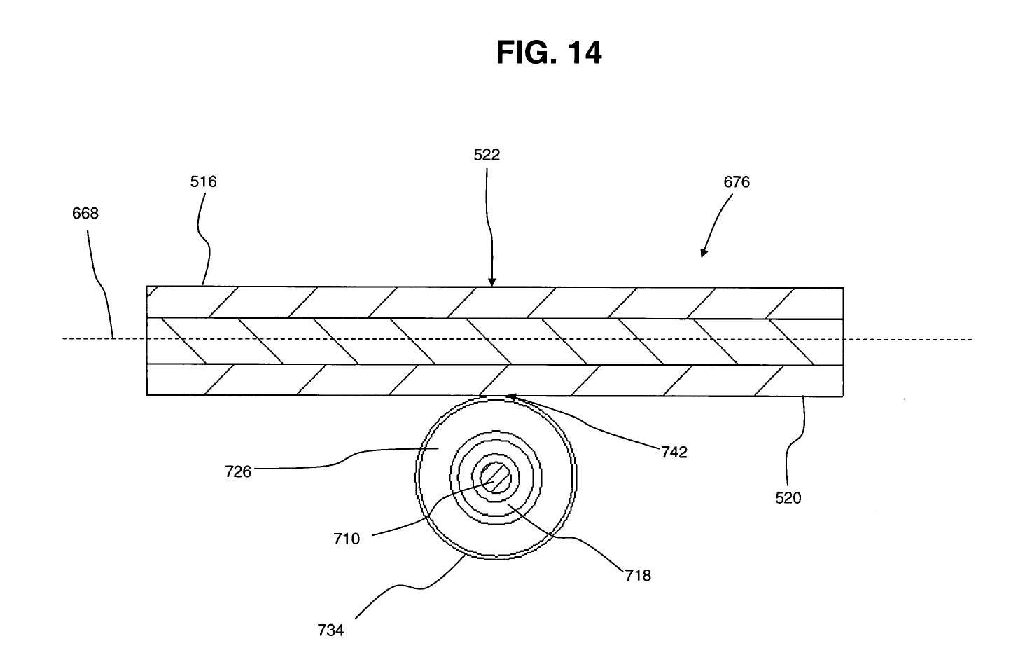

The components comprising roller assembly 570, as well as the interaction of and relationship between, roller assembly 570 and disk 510, are further illustrated by FIGS. 13 and 14. FIG. 13 shows an enlarged encircled portion of the FIG. 11 indicated by arrow 700. As shown in FIG. 13, roller assembly 570 further comprises a roller shaft 710 which is rotatably mounted by support 564. Roller assembly 570 further comprises a roller bearing 718 mounted at or on the distal end of shaft 718, as well as a roller 726 mounted on bearing 718 and having an outer surface 734 that is in contact with and engages lower surface 520 of disk 510 proximate peripheral portion 514. As shown in FIG. 13, roller 726 rotates about an axis (as defined by shaft 710) that is transverse to the plane defined by disk 510.

Roller 726 may comprise a relatively flexible or soft material, but often comprises a relatively stiff material such as metal (e.g., may comprise stainless steel) to lessen or minimize the generation of debris (e.g., from the material comprising roller 726) that may occur due to the friction between outer surface 734 and lower surface 520 of disk 510, as roller 726 rotates about shaft 710 in response to the rotation of disk 510. A roller 726 comprising a relatively stiff material such as metal also provides better control of the deflection of disk 510. As further shown in FIG. 13, outer surface 734 of roller 726 may be configured or profiled (e.g., be slanted or angled outwardly from inner portion 736 adjacent support 564 to outer portion 738 away from support 564 such that outer portion 738 has a diameter greater than the diameter of inner portion 736) and/or may be positioned (e.g., to provide only the radius 740) such that surface 734 provides a relatively thin, narrow or tangential annular line of contact, as indicated by 742, that actually engages lower surface 520 of disk 510.

Providing a relatively tangential annular line of contact 742 may lessen or minimize slippages of lower surface 520 of disk 10, relative to outer surface 734 of roller 726, by minimizing the differences in the rotation rate between the inner and outer radii of disk 510 contacted by line of contact 742. Such slippages may cause scratches to lower surface 520 of disk 510, as well as generate debris between lower surface 520 of disk 510 and roller 726. As shown in FIG. 13 and particularly in FIG. 14, this tangential annular line of contact 742 may also be sufficient for roller 726 to deflect disk 510 upwardly such that deflected portion 676 of disk 510 adjacent to radial line 522 may be substantially level with the normal record and/or read plane 668. In addition to compensating for any displacement of disk 510 from the normal record and/or read plane 668 due to either deliberate or normal axial tilting 660 of disk 510 when coupled to spindle 642 (e.g., displacement such as that illustrated in FIG. 5), deflected portion 676 may also cause sufficient smoothing or flattening of, for example, any inherent waviness of disk 510 along and adjacent to radial line 522 (e.g., waviness such as that illustrated in FIG. 4).

It should be appreciated that the specific embodiments illustrated in FIGS. 8 through 14 are provided to illustrate the teachings of the present invention. Alterations or modification within the skill of the art of the specific embodiments illustrated in FIGS. 8 through 14 are considered within the scope of the present invention, so long as these alterations or modifications operate in a same or similar manner, function, etc. These modifications may include the use of a single element, component or mechanism (in place of a plurality of elements, components or mechanisms), etc., the use of a plurality of elements, components or mechanisms (in place of a single of element, component or mechanism), the changing of the order, orientation, position, etc., of any of the elements, components or mechanisms, the combining or integrating of any of the elements, components or mechanisms into a single or unified element, component or mechanism, or the ungrouping of an element, component or mechanism into a plurality of associated elements, components or mechanisms, etc. For example, while the specific embodiments illustrated in FIGS. 8 through 14 show disk 310/510 being oriented generally horizontally, with spindle drive assembly 624 being oriented generally vertically, disk 310/510 may also be oriented generally vertically, with spindle drive assembly 624 being oriented generally horizontally.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An apparatus comprising:
a disk medium coupler for releasably coupling and uncoupling a holographic disk medium, the disk medium having first and second laterally spaced apart surfaces and an outer peripheral portion; and
means engaging at least one of the first and second surfaces proximate the peripheral portion to thereby stabilize the disk medium against vibrations when the disk medium is coupled to the disk medium coupler.

2. The apparatus of claim 1, wherein the disk medium has a generally circular shape and wherein the peripheral portion has a generally annular shape.

3. The apparatus of claim 1, wherein the stabilizing means comprises a rotatable roller having an outer surface engaging at least one of the first and second surfaces.

4. The apparatus of claim 3, wherein the disk medium coupler has a rotational axis and wherein the roller has a rotational axis that is transverse relative to the rotational axis of the disk medium coupler.

5. The apparatus of claim 3, wherein the outer surface of the roller engages only one of the first and second surfaces.

6. The apparatus of claim 5, wherein the first surface is an upper surface and wherein the second surface is a lower surface, and wherein the outer surface of the roller engages the lower surface.

7. The apparatus of claim 5, wherein the outer surface of the roller provides a relatively tangential annular line of contact that engages the lower surface.

8. An apparatus comprising:
a disk medium coupler for releasably coupling and uncoupling a holographic disk medium, the disk medium having an outer peripheral portion;
means for stabilizing the disk medium proximate the peripheral portion against vibrations when the disk medium is coupled to the disk medium coupler; and
means for coupling and uncoupling the disk medium to and from the disk medium coupler; and for causing the stabilizing means to engage the disk medium when coupled to the disk medium coupler.

9. The apparatus of claim 8, wherein the disk medium has a generally circular shape and wherein the peripheral portion has a generally annular shape.

10. That apparatus of claim 8, wherein the coupling and uncoupling means comprises a disk medium carrier for releasably receiving the disk medium.

11. The apparatus of claim 10, wherein the stabilizing means comprises a roller assembly having a rotatable roller with an outer surface engaging the peripheral portion.

12. The apparatus of claim 11, wherein the disk medium has upper and lower laterally spaced apart surfaces and wherein the outer surface of the roller engages the lower surface.

13. The apparatus of claim 12, wherein the disk medium coupler has a rotational axis and wherein the roller has a rotational axis that is transverse relative to the rotational axis of the disk medium coupler.

14. The apparatus of claim 12, wherein the outer surface of the roller provides a relatively tangential annular line of contact that engages the lower surface.

15. The apparatus of claim 12, wherein the disk medium is rotatably mounted within a housing of data storage cartridge, and wherein the disk medium carrier is a cartridge carrier.

16. The apparatus of claim 15, which further comprises a cartridge carrier transporter for moving the cartridge carrier laterally between loading and unloading positions, and wherein the roller assembly is associated with the cartridge carrier transporter.

17. The apparatus of claim 16, wherein the disk medium defines a plane, wherein the roller assembly is mounted on the cartridge carrier transporter, wherein the roller has a rotational axis that is transverse relative to the disk medium plane, and wherein the roller further imparts an axial offset to the lower surface proximate the peripheral portion to deflect a record and/or read portion of the disk medium towards a normal record and/or read plane.

18. The apparatus of claim 17, wherein the outer surface of the roller provides a relatively tangential annular line of contact that engages the lower surface.

19. The apparatus of claim 17, wherein the normal record and/or read plane is substantially horizontal, and wherein the roller imparts an axial offset to the lower surface that causes the deflected portion to be substantially level with the normal record and/or read plane.

20. The apparatus of claim 19, wherein the disk medium coupler is axially tilted to cause the roller to impart a consistent axial offset to the lower surface.

21. An apparatus comprising:
a holographic data storage cartridge having:
a holographic disk medium having an outer peripheral portion; and
a housing for rotatably mounting the disk medium; and
means associated with the housing for stabilizing the disk medium proximate the peripheral portion against vibrations when the disk medium is coupled to a disk medium coupler.

22. The apparatus of claim 21, wherein the disk medium has a generally circular shape and wherein the peripheral portion has a generally annular shape.

23. The apparatus of claim 21, wherein the stabilizing means is mounted within the housing.

24. The apparatus of claim 23, wherein the disk medium has a peripheral edge, and wherein the stabilizing means comprises a rotatable roller having an outer surface that engages the peripheral edge.

25. The apparatus of claim 24, wherein the stabilizing means further comprises a roller support mounted within the housing, and wherein the roller is rotatably mounted proximate one end of the roller support.

26. The apparatus of claim 25, wherein the disk medium rotates about a rotational axis, and wherein the roller rotates about a rotational axis that is generally parallel to the rotational axis of the disk medium.

27. The apparatus of claim 25, wherein the stabilizing means further comprises means for urging the roller towards the peripheral edge such that the outer surface of the roller continually engages the peripheral edge.

28. An apparatus comprising:
a disk medium coupler for releasably coupling and uncoupling a holographic disk medium having an outer peripheral portion; and
means for imparting an axial offset to the disk medium proximate the peripheral portion to deflect a record and/or read portion of the disk medium towards a normal record and/or read plane when coupled to the disk medium coupler.

29. The apparatus of claim 28, wherein the axial offset imparting means additionally stabilizes the disk medium proximate the peripheral portion against vibrations when the disk medium is coupled to the disk medium coupler.

30. The apparatus of claim 28, wherein the axial offset imparting means causes the deflected portion is curved upwardly.

31. The apparatus of claim 30, wherein the deflected portion comprises a radial line of the disk medium.

32. The apparatus of claim 30, wherein the disk medium has first and second laterally spaced apart surfaces, and wherein the axial offset imparting means engages at least one of the first and second surfaces.

33. The apparatus of claim 32, wherein the disk medium has a generally circular shape and wherein the peripheral portion has a generally annular shape.

34. The apparatus of claim 32, wherein the axial offset imparting means engages only one of the first and second surfaces.

35. The apparatus of claim 34, wherein the axial offset imparting means comprises a rotatable roller having a rotational axis transverse to a plane defined by the disk medium and wherein the roller comprises an outer surface engaging one of the first and second surfaces.

36. The apparatus of claim 35, wherein the outer surface provides a relatively tangential annular line of contact that engages one of the first and second surfaces.

37. The apparatus of claim 35, wherein the normal record and/or read plane is substantially horizontal, wherein the first surface is an upper surface and the second surface is a lower surface, and wherein the outer surface of the roller engages the lower surface.

38. The apparatus of claim 37, wherein the disk medium coupler is axially tilted to cause the roller to impart a consistent axial offset to the lower surface.

39. A method comprising the following steps:
(a) providing a holographic disk medium having first and second laterally spaced apart surfaces and an outer peripheral portion; and
(b) engaging at least one of first and second surfaces proximate the peripheral portion to stabilize the disk medium against vibrations during recording of holograms to or reading of holograms from the disk medium.

40. The method of claim 39, wherein step (b) is carried out by stabilizing the disk medium against vibrations comprising axial and radial vibrations.

41. The method of claim 39, wherein step (b) is carried out by engaging only one of the first and second surfaces.

42. The method of claim 41, wherein step (b) is carried out by bringing a rotatable roller into engagement with one of the first and second surfaces.

43. The method of claim 42, wherein step (b) is carried out by bringing the roller into continuous engagement with one of the first and second surfaces.

44. A method comprising the following steps:
(a) providing a holographic disk medium having an outer peripheral portion; and
(b) engaging the disk medium proximate the peripheral portion to thereby stabilize the disk medium against vibrations and to deflect a record and/or read portion of the disk medium towards a normal record and/or read plane during recording of holograms to or reading of holograms from the disk medium.

45. The method of claim 44, wherein the disk medium provided in step (a) has first and second laterally spaced apart surfaces, and wherein step (b) is carried out by engaging at least one of the first and second surfaces.

46. The method of claim 45, wherein the disk medium provided in step (a) has an upper surface and a lower surface, and wherein step (b) is carried out by engaging the lower surface so that the deflected portion is deflected towards a normal record and/or read plane that is substantially horizontal.

47. The method of claim 46, wherein step (b) is carried out by a roller engaging the lower surface, wherein the roller has a rotational axis that is transverse to a plane defined by the disk medium.

48. The method of claim 47, wherein step (b) is carried out by the roller imparting an axial offset to the peripheral portion such that the deflected portion is curved upwardly.

49. The method of claim 48, wherein step (b) is carried out such that the deflected portion comprises a radial line of the disk medium.
